(19) United States
(12) Patent Application Publication
(10) Pub. No.: US 2011/0122109 A1
(43) Pub. Date: May 26, 2011

(54) REFLECTIVE DISPLAY DEVICE AND CONTROL CIRCUIT FOR REFLECTIVE DISPLAY DEVICE

(75) Inventor: Masaki NOSE, Kawasaki (JP)

(73) Assignee: FUJITSU LIMITED, Kawasaki-shi (JP)

(21) Appl. No.: 12/952,337

(22) Filed: Nov. 23, 2010

(30) Foreign Application Priority Data
Nov. 24, 2009 (JP) 2009-266815

(51) Int. Cl. G09G 5/00; G09G 3/36

(52) U.S. Cl. 345/207; 345/87

(57) ABSTRACT

There is provided a reflective display device that includes an illuminance detector configured to detect illuminance, a chroma corrector configured to correct chroma of image data in accordance with the illuminance detected by the illuminance detector, and a display element configured to display image data corrected by the chroma corrector.

### CROSS-REFERENCE TO RELATED APPLICATION

This application is based upon and claims the benefit of priority of the prior Japanese Patent Application No. 2009-266815, filed on Nov. 24, 2009, the entire contents of which are incorporated herein by reference.

### FIELD

The present invention relates to a reflective display device and a control circuit of the reflective display device.

### BACKGROUND

Electronic paper is extensively developed in various companies, universities, etc. in recent years. Various forms of applications are proposed for application fields in which electronic paper is expected to be used, such as electronic books first on the list, sub-displays of mobile terminal devices, display units of IC cards, etc. One of leading technologies for electronic paper is cholesteric liquid crystal. The cholesteric liquid crystal has excellent features such as semi-permanent storage of displayed image (memory characteristic), vivid color display, high contrast and high-resolution characteristics.

The cholesteric liquid crystal is sometimes called chiral nematic liquid crystal, in which an additive of a chiral characteristic is added to nematic liquid crystal relatively much (several tens of percent) so that molecules of the nematic liquid crystal form a helical cholesteric phase. A cholesteric liquid crystal display device displays an image on a screen by using an orientation state of the liquid crystal molecules.

FIGS. 10A and 10B illustrate a state of the cholesteric liquid crystal. As illustrated in FIGS. 10A and 10B, a display element using the cholesteric liquid crystal has an upper substrate 110, a cholesteric liquid crystal layer 120, and a lower substrate 130. The cholesteric liquid crystal has two states. One is a planar state in which incident light is reflected as illustrated in FIG. 10A and the other is a focal conic state in which incident light passes as illustrated in FIG. 10B. These states are steadily maintained even if no electric field is applied.

In the planar state, the display element reflects light of a wavelength corresponding to a helical pitch of the liquid crystal molecules. A wavelength 2, which maximizes the reflection is represented by an average refractive index n of the liquid crystal and the helical pitch p as follows:

λ=n×p

Meanwhile, a reflection bandwidth Δλ changes much depending upon refractive index anisotropy Δn of the liquid crystal.

The display element reflects incident light in the planar state and may thereby display white in a “light” state. Meanwhile, the display element provided with a light absorbing layer below the lower substrate 13 absorbs light having passed the liquid crystal layer, and may thereby display black in a “dark” state.

Then, a method for driving the display element using the cholesteric liquid crystal will be explained. If a specific high voltage (e.g., ±36 volts) is applied between electrodes to generate a relatively strong electric field in the cholesteric liquid crystal, the helical structures of the liquid crystal molecules completely disappear resulting in that all the molecules are oriented in the direction of the electric field in a homeotropic state. Then, if the applied voltage is abruptly changed downwards from the high voltage to a specific low voltage (e.g., within ±4 volts) to make the electric field abruptly about zero in the homeotropic state of the liquid crystal molecules, the liquid crystal enters into the planar state in which the helical axes of the liquid crystal are perpendicular to the electrodes and the light corresponding to the helical pitch is selectively reflected.

Meanwhile, if a specific low voltage (e.g., ±24 volts) is applied between the electrodes to generate a relatively weak electric field the cholesteric liquid crystal, the helical structures of the liquid crystal molecules do not completely disappear and some of them remain. If, in this state, the applied voltage is abruptly changed downwards and the electric field is abruptly made about zero, or if a strong electric field is applied and then the electric field is slowly removed, the liquid crystal enters into the focal conic state in which the helical axes of the liquid crystal molecules are parallel to the electrodes and the incident light passes. Further, if an electric field of middle strength is applied and then the electric field is abruptly removed, the planar state and the focal conic state are mixed so that a halftone display is enabled.

A principle of the driving method based on the voltage response characteristic described above will be explained. FIGS. 11A, 11C and 11E illustrate waveforms of voltage pulses. FIGS. 11B, 11D and 11F illustrate pulse response characteristics corresponding to the applied voltage pulses illustrated in FIGS. 11A, 11C, and 11E, respectively. FIG. 11A illustrates a voltage pulse having voltages of ±36 volts and a pulse width of several tens of milliseconds (ms). FIG. 11C illustrates a voltage pulse having ON-voltages of ±20 volts, OFF-voltages of ±10 volts and a pulse width of 2 ms. FIG. 11E illustrates a voltage pulse having ON-voltages of ±20 volts, OFF-voltages of ±10 volts and a pulse width of 1 ms. In each of FIGS. 11B, 11D, and 11F, horizontal and vertical axes represent voltage (V) and reflectance or reflectivity (percent), respectively. The voltage pulse used here is formed by a combination of pulses of positive and negative polarity as a well-known pulse for driving the liquid crystal so that the liquid crystal is prevented from being degraded by ionic polarization, etc.

In the case of a large pulse width illustrated in FIGS. 11A and 11B, if the voltage is raised into a certain range in the planar state as an initial state, the state changes to the focal conic state. With further increasing the voltage, the state returns to the planar state. If the initial state is the focal conic state, the state gradually changes to the planar state as the pulse voltage is further raised.

Pulse voltages inevitably causing the planar state are ±36 volts in the case of a large pulse width regardless of whether the initial state is the planar state or the focal conic state as illustrated in FIG. 11B. Further, a middle voltage between the above voltages causes the planar state and the focal conic state to be mixed so that a halftone display is enabled.

With reference to FIGS. 11C and 11D, will be explained the case of the pulse width of 2 ms. The pulse voltages in the range of ±10 volts do not cause the change in the reflectivity when the initial state of the liquid crystal is in the planar state. If the voltage further grows, the reflectivity decreases in the mixed state of the planar and focal conic states. Although growing as the voltage grows, the decrease of the reflectivity levels off at the voltage beyond the range±36 volts, which does not change if the initial state is the mixed state of the planar and focal conic states. Thus, when a voltage pulse having a pulse width of 2 milliseconds and pulse voltages of ±20 volts is applied once in an initial state being the planar state, the reflectivity decreases to some extent. After the reflectivity decreases a little in the mixed state of the planar and focal conic states and if another voltage pulse having a pulse width of 2 milliseconds and pulse voltages of ±20 volts is further applied, the reflectivity further decreases. If such a cycle is repeated, the reflectivity decreases down to a specific value.

With reference to FIGS. 11E and 11F, the applied voltage pulse of pulse width of 1 millisecond causes the reflectivity to decrease similarly as in the case of the pulse width of 2 milliseconds, while the decrease of the reflectivity is smaller than that in the case of the pulse width of 2 milliseconds.

As described above, the planar state is caused by an application of a pulse of a pulse width of several tens of milliseconds and 36 volts. Further, the planar state changes to the mixed state of the planar and focal conic states resulting in that the reflectivity decreases when a pulse of a pulse width of 2 milliseconds and a dozen to about 20 volts is applied. The decrease of the reflectivity presumably relates to accumulated pulse widths.

Various methods for implementing electronic paper are proposed such as an electrophoresis method, an electrochromic method, etc., in addition to the cholesteric liquid crystal. The electronic paper including the cholesteric liquid crystal display device has a display-image storing characteristic, and may semi-permanently hold a display image while being supplied with no power and display the image in a way like holding the image in memory. The electronic paper is thereby fit for use such as displaying a same image in a way like holding the image in memory for a long period of time. As display performance of a display device of such a reflective type depends upon environmental light, however, there is a problem in that the visibility of the reflective display device is much degraded in a dark environment. Japanese Laid-open Patent Publications 2000-231092, 2006-285063, and 2004-354872 disclose arts for easing the problem caused by the environmental light as described below.

Japanese Laid-open Patent Publication 2000-231092 discloses a reflective display device from a guest-host type liquid crystal device down. The reflective display device has a means for detecting light and a drive controller, and carries out following two control operations. (1) If detected light is of a characteristic such that white balance may be secured, the drive controller is adjusted so as to hold the white balance as much as possible. (2) If a contrast-oriented display is required, may be performed a mode for amplifying voltage so that maximum voltages are applied to respective R, G, and B components.

There are following problems, however, in the disclosure in the Patent Publication. (a) there are provided only two modes, i.e., either an ordinary display (or secured white balance) or the contrast-oriented display. (b) As the mode should be selected from the two modes as two extreme display modes, the contrast-oriented display may possibly cause an inappropriate display such as a lack of information.

Japanese Laid-open Patent Publication 2006-285063 discloses that signal processing for enhancing visibility including a brightness stressing process, a color signal stressing process and a hue control process are carried out on a display panel of a light emitting type. In detail, the Patent Publication discloses (1) to control the display for making brightness adjustment and color gain adjustment stronger as an average brightness level is lower (the image is dark) or an illuminance signal level is higher (the environment is light) when the illuminance is higher than a specific value, and (2) to control the display for making the brightness adjustment and the color gain adjustment stronger as the average brightness level is lower (the image is dark) or the illuminance signal level is lower (the environment is dark) when the illuminance is lower than the specific value. Moreover, image processing for stressing red color is performed for compensating for a Purkinje effect.

As the art disclosed in Japanese Laid-open Patent Publications 2006-285063 relates to the light emitting type, it is advantageous for an image appearance to make the color gain adjustment stronger as the environment is darker. Meanwhile, it is not necessarily more advantageous to hue information on a reflective display that the environment is darker.

Japanese Laid-open Patent Publication 2004-354872 discloses an art for detecting external illuminance of a portable electronic device and for adjusting and controlling three factors of brightness, contrast and hue in accordance with the detected external illuminance. According to the art disclosed in this Patent Publication, however, how the brightness, contrast and hue is specifically adjusted is not mentioned, and it is difficult to estimate an optimum adjusting means for the reflective display such as electronic paper.

### SUMMARY

According to an aspect of the invention, a reflective display device includes an illuminance detector configured to detect illuminance, a chroma corrector configured to correct chroma of image data in accordance with the illuminance detected by the illuminance detector, and a display element configured to display image data corrected by the chroma corrector.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a simplified cross section of a display element included in a display device of a layered structure of a first embodiment;

FIG. 2 illustrates a configuration of the display device of the embodiment;

FIG. 3 is a block diagram for illustrating a whole configuration of a driving circuit;

FIG. 4 illustrates an exemplary flowchart carried out by the driving circuit;

FIG. 5 illustrates a logarithmic relation between illuminance (in lx) and an illumi value;

FIGS. 6A and 6B illustrate an exemplary process for stressing contrast;

FIGS. 7A and 7B are image diagrams for illustrating a relationship between a decrease of chroma and the contrast;

FIG. 8 illustrates an exemplary flowchart for identifying whether the display is updated or not;

FIG. 9 is a functional block diagram of a display device of a second embodiment;

FIGS. 10A and 10B illustrate the states of the cholesteric liquid crystal; and

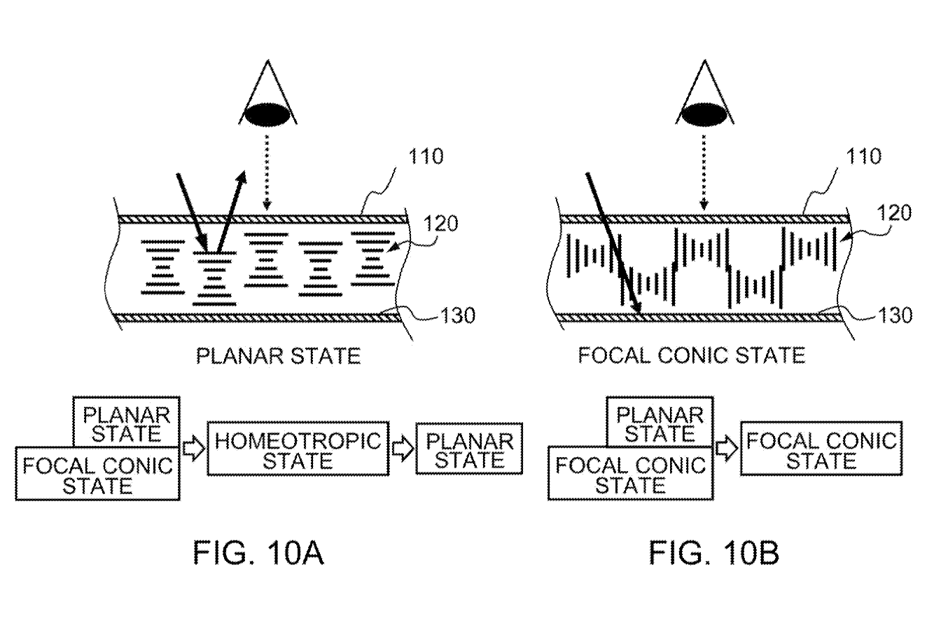

FIGS. 11A to 11F illustrate waveforms of voltage pulses and pulse response characteristics.

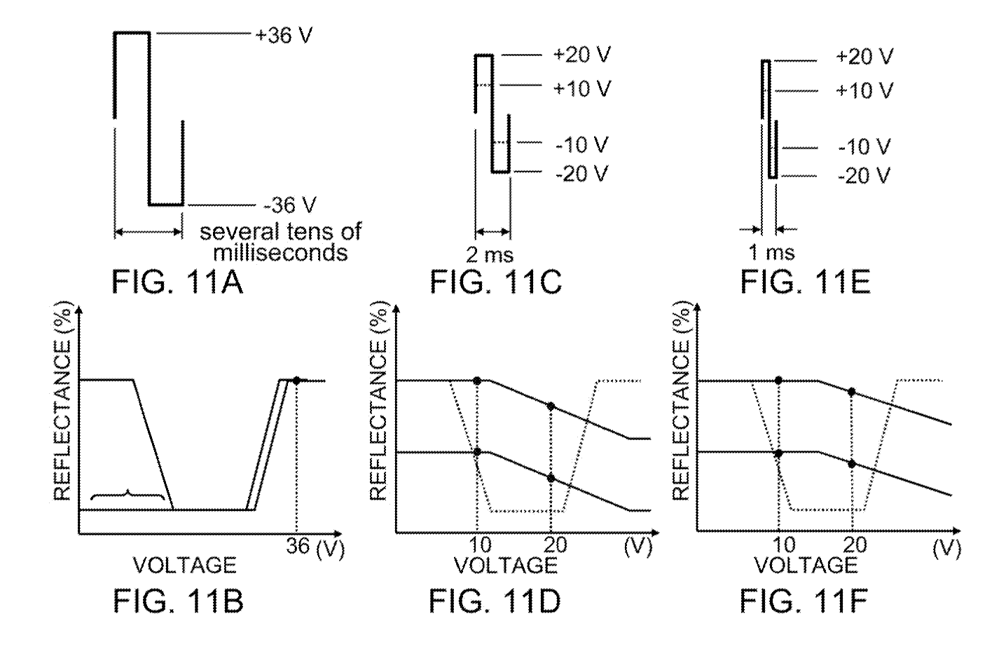

### DESCRIPTION OF EMBODIMENTS

Embodiments will be explained hereafter with reference to the drawings.

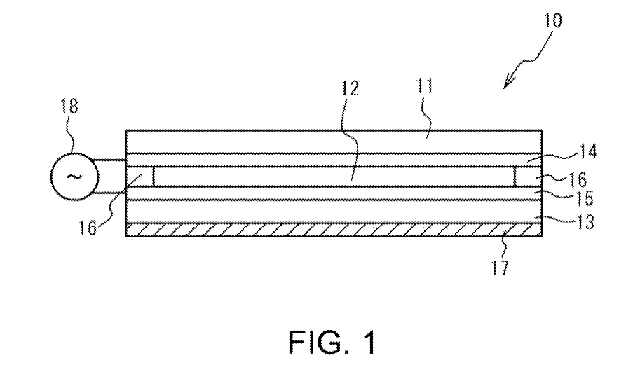

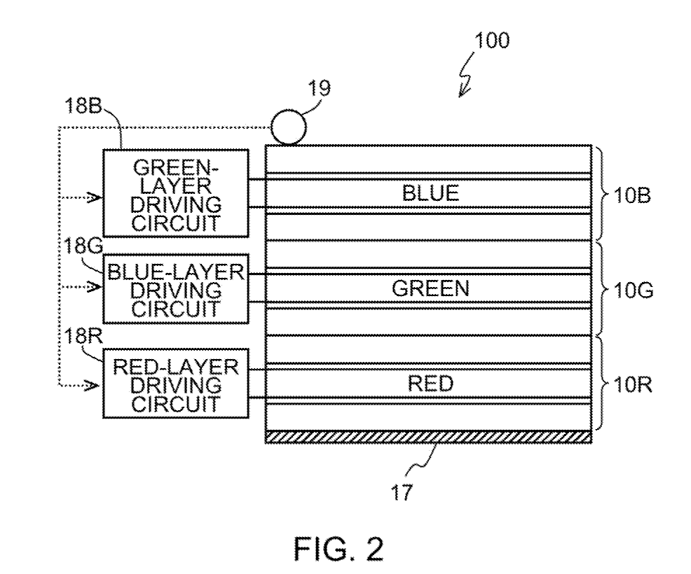

FIG. 1 is a simplified cross section of a display element 10 included in a reflective display device 100 of a first embodiment, which will be found in FIG. 2. The display device 100 is used, e.g., for color electronic paper, etc. As illustrated in FIG. 1, the display element 10 includes an upper substrate 11, an upper electrode 14 provided at the lower side of the upper substrate 11, a lower substrate 13, a lower electrode 15 provided at the upper side of the lower substrate 13, and a sealing material 16. Further, a visible light absorbing layer 17 is provided as necessary below the lower substrate 13 (on an external face) positioned opposite the side of light incidence.

The upper substrate 11 and the lower substrate 13 are arranged in such a way that the electrodes 14 and 15 face each other, and are sealed with the sealing material 16 after a liquid crystal layer 12 is enclosed between the upper substrate 11 and the lower substrate 13. A spacing support may be arranged in the liquid crystal layer 12. A driving circuit 18 applies a voltage pulse signal to the upper electrode 14 and the lower electrode 15 so that voltage is applied to the liquid crystal layer 12. The liquid crystal layer 12 is a cholesteric liquid crystal composition which shows a cholesteric phase. Voltage is applied to the liquid crystal layer 12 so that liquid crystal molecules in the liquid crystal layer 12 are put in the planar state or in the focal conic state. The screen to be displayed is composed with use of these states.

Both the upper substrate 11 and the lower substrate 13 have transparency, however, the lower substrate 13 is allowed to be opaque. The substrates having transparency includes a glass substrate, and film substrates such as PET (polyethylene terephthalate) or PC (polycarbonate) may be used instead of the glass substrate.

The upper electrode 14 and the lower electrode 15 are transparent electrodes. Indium tin oxide (ITO), e.g., is representative of the material for the transparent electrodes. In addition, transparent conductive membrane such as indium zinc oxide (IZO) may be used.

The upper electrode 14 is formed on the upper substrate 11 by a plurality of upper transparent electrodes each of which is a strip-shape and parallel to one another. The lower electrode 15 is formed on the lower substrate 13 by a plurality of lower transparent electrodes each of which is a strip-shape and parallel to one another. The upper substrate 11 and the lower substrate 13 are arranged in such a way that the upper and lower electrodes cross as viewed in a direction perpendicular to the substrates, and pixels are formed on the crossings.

Electrical insulating thin films are formed on each of the electrodes 14 and 15. If the thin film is thick, driving voltage needs to be high, and it turns difficult to form a driving circuit by using an all-purpose driver for STN-use, etc. In the absence of the thin film, conversely, a leak current increases and causes a problem of a power consumption increase. Incidentally, as a relative permittivity of the thin film is about five and much lower than that of the liquid crystal, the thin film may preferably be about 0.3 μm or less in thickness. Incidentally, the thin film (the electrical insulating thin film) may be implemented by a thin film of SiO₂ or organic membrane such as polyimide resin or acryl resin both of which are known as films for alignment stabilization.

Incidentally, spacers may be provided between the upper substrate 11 and the lower substrate 13 so as to make an inter-substrate gap evenly spaced. A sphere made of resin or inorganic oxide may be used as the spacer. Further, an adhesive spacer superficially coated with thermoplastic resin may be used, as well. A cell gap formed by the spacers may preferably be around 4-6 μm in separation. A cell gap of a separation smaller than that range causes a decrease of the reflectivity and a dark display resulting in that high threshold steepness may be barely expected. Meanwhile, although being able to secure high threshold steepness, a cell gap of a separation larger than that range causes driving voltage to be high and makes it difficult to drive the display element by using all-purpose parts.

The cholesteric liquid crystal which forms the liquid crystal layer 12 is formed by mixed nematic liquid crystal to which chiral material is added by 10-40 wt-percent. The addition rate of the chiral material shows a value on the assumption that a total amount of the nematic liquid crystal component and the chiral material corresponds to 100 wt-percent. Various kinds of nematic liquid crystal well known may be used. Nematic liquid crystal is preferably one having permittivity anisotropy Δε in the range 15≦Δε≦25 for relative low voltage for driving the liquid crystal layer 12. If the permittivity anisotropy Δε is greater than that range, the liquid crystal layer 12 has small relative resistance, although the voltage itself for driving the liquid crystal layer 12 may be made low. Thus, the display element 10 undesirably consumes more power particularly in high temperature condition. Further, a value of refractive index anisotropy Δn of the cholesteric liquid crystal may preferably be 0.18≦Δε≦0.26. If the refractive index anisotropy Δn is smaller than that range, the reflectivity of the liquid crystal layer 12 is rendered low in the planar state. If the reflectivity anisotropy Δn is greater than that range, the liquid crystal layer 12 causes great scattering reflection in the focal conic state, and causes higher viscosity and lower speed of response as well.

FIG. 2 illustrates a configuration of the display device 100 according to the embodiment. As illustrated in FIG. 2, the display device 100 has a layered structure of panel element including display elements 10B, 10G, and 10R. The display elements 10B, 10G, and 10R provide blue, green, and red reflective color, respectively. The visible light absorbing layer 17 is provided below the display element 10R. Further, an illuminance sensor 19 is provided on a light incidence side of the display element 10B. The illuminance sensor 19 is formed by, e.g., a photosensitive element such as a photodiode. Incidentally, where the illuminance sensor 19 is placed is not limited in particular, and the illuminance sensor 19 is placed where environmental illuminance of the display device 100 may be detected.

The three display elements 10B, 10G and 10R are similarly structured as the display element shown in FIG. 1, and have different wavelength characteristics each other. The liquid crystal material, the chiral material and the content by percentage of the chiral material of the display element 10B are chosen in such a way that a central wavelength of the reflection is blue (approximately 480 nm). Those of the display element 10G are chosen in such a way that a central wavelength of the reflection is green (approximately 550 nm). Those of the display element 10R are chosen in such a way that a central wavelength of the reflection is red (approximately 630 nm). The illuminance sensor 19 detects the environmental illuminance to which the display device 100 is exposed, and provides driving circuits 18B, 18G, and 18R for the blue, green and red layers, respectively, with what is detected. The display elements 10B, 10G and 10R are driven by the driving circuits 18B, 18G and 18R, respectively.

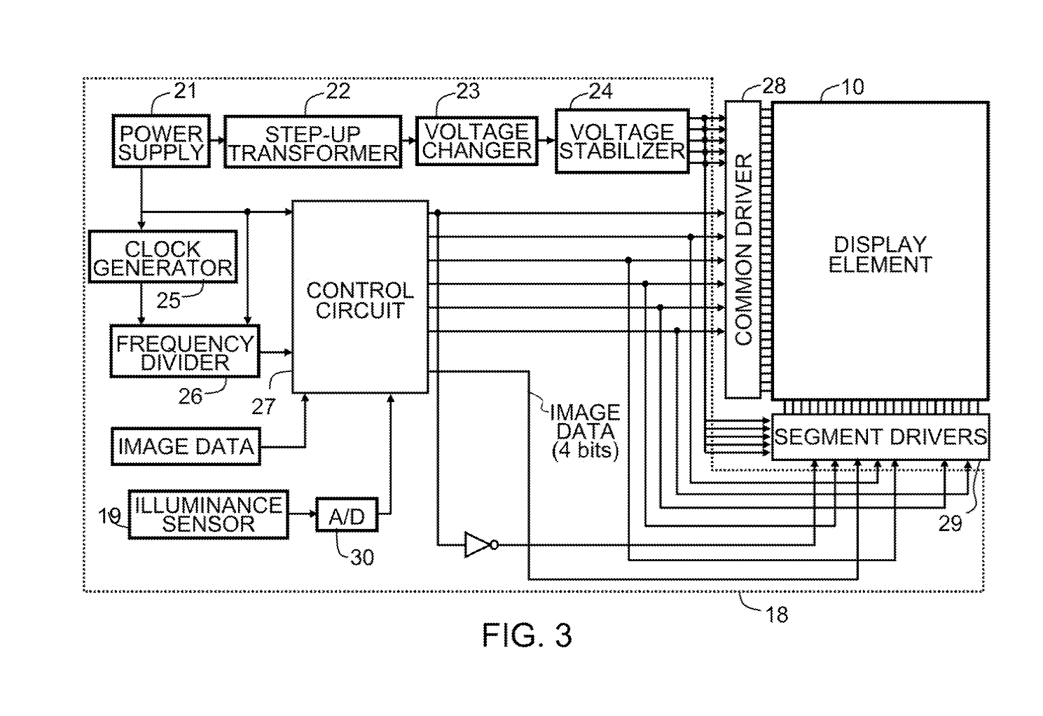

FIG. 3 is a block diagram for illustrating a whole configuration of the driving circuit 18. FIG. 3 illustrates a case in which, e.g., the display element 10 is A4-sized (297 mm by 210 mm) and has 1024×768 pixels in accordance with the XGA specification. The driving circuit 18 includes a power supply 21, a step-up transformer 22, a voltage changer 23, a voltage stabilizer 24, a segment driver 29 and an A/D (analog/digital) converter 30.

The power supply 21 provides voltage of, e.g., 3-5 volts. The step-up transformer 22 steps up the input voltage provided by the power supply 21 to 36-40 volts by using a regulator such as a DC-DC converter. Such type of step-up regulator widely uses an exclusive IC which has a function for adjusting the stepped-up voltage by setting a feedback voltage to the IC. Thus, the regulator may be configured to choose a plurality of voltages produced by resistor-dividing, etc., and to provide a feedback terminal with the chosen voltage, so as to change the stepped-up voltage.

The voltage changer 23 produces various voltages by resistor-dividing, etc. The voltage changer 23 may use an analog switch of high withstand voltage for switching a reset voltage and a gradation (halftone) writing voltage, and may use a switching circuit simply formed by transistors. The voltage stabilizer 24 may preferably use a voltage follower circuit of an operational amplifier so as to regulate the various voltages supplied by the voltage changer 23. It is preferable to use an operational amplifier having a sufficient characteristic to a capacitive load. Incidentally, a configuration for switching amplifier gains over by changing resistors connected with the operational amplifier is widely known. Thus, the use of this configuration may easily enable a switchover of the voltage provided by the voltage stabilizer 24.

A clock generator 25 generates a primary clock signal on which operations are based. A frequency divider 26 divides the frequency of the primary clock signal so as to generate various clock signals necessary for operations described later. A control circuit 27 generates a control signal on the basis of the primary clock signal, the various clock signals and image data D, and transmits the control signal to a common driver 28 and a segment driver 29.

The common driver 28 drives 768 scan lines as directed by the control circuit 27. The segment driver 29 drives 1024 data lines as directed by the control circuit 27. As pieces of image data provided to respective R (red), G (green), and B (blue), that is RGB, pixels are different, the segment driver 29 drives the respective data lines independently. The common driver 28 drives the R, G, and B lines in common. One of driver ICs to be used for the embodiment is an all-purpose STN driver of a binary output. Various types of driver ICs may be used.

The segment driver 29 is provided with four-bit image data D0-D3 such that a full-color original image is converted into data of 4096 colors, i.e., 16 gradations (halftones) for each of R (red), G (green), and B (blue) color components, by means of an error diffusion method. It is preferable to use a gradation conversion (tone correction) method which may achieve high display quality, and a blue noise masking method, etc., may be used as well as the error diffusion method. Further, a process for enhancing image quality such as a contrast stressing process may be performed before or after the gradation conversion. The illuminance sensor 19 converts the environmental illuminance of the display device 100 into an analog current. The analog current provided by the illuminance sensor 19 is converted into a digital signal by the A/D converter 30 and is provided to the control circuit 27.

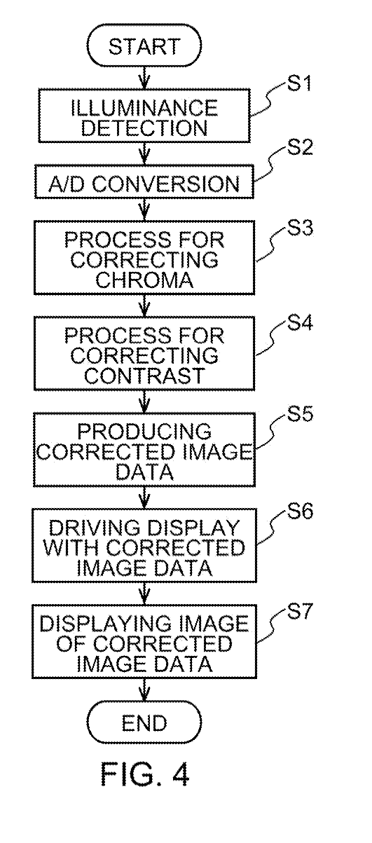

FIG. 4 illustrates an exemplary flowchart carried out by the driving circuit 18. As illustrated in FIG. 4, the illuminance sensor 19 converts the environmental illuminance of the display device 100 into an analog current to result in the illuminance detection (step S1). Then, the A/D converter 30 converts the analog signal provided by the illuminance sensor 19 into a digital signal (step S2). Then, the control circuit 27 performs a process for correcting chroma of the original image data on the basis of an output value of the A/D converter 30 (step S3). Then, the control circuit 27 performs a process for correcting contrast of the original image data (step S4).

Then, the control circuit 27 produces corrected image data from the chroma and the contrast obtained at the steps S3 and S4, respectively (step S5). Then, the common driver 28 and the segment driver 29 drive the display element 10 on the basis of the corrected image data produced at the step S5. The display element 10 thereby updates a displayed image (step S6).

The steps S3 and S4 will be explained in detail below. The illuminance detected by the illuminance sensor 19 will be explained at first. The illuminance may be associated with an “illumi” value, which defines as a value is, e.g., within a range 0-1 and may be made “1” and “0” outdoors in fine weather and in a darkroom, respectively. An exemplary relationship between the environment and the illuminance in lux (lx) is illustrated in Table 1.

TABLE 1

| | Illuminance |
|---|---|
| Environment | (lx) |
| Moonlight of a full moon | 0.2 |
| Candlelight 30 cm apart from the candle) | 15 |
| Under Streetlight | 100 |
| Office | 800 |
| Outdoors in cloudy weather | 10000 |
| Outdoors in fine weather | 100000 |
| Outdoors in full summer | 200000 |

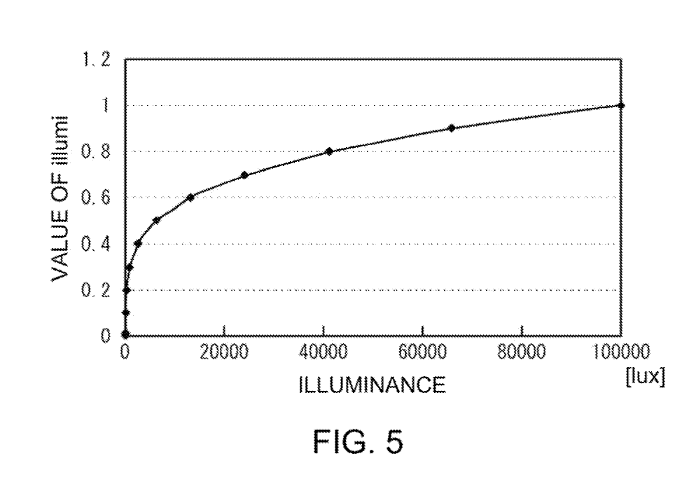

Incidentally, the illumi value may be made “1” and “0” if the illuminance is higher than 100000 lx and lower than 0.1 lx, respectively. Further, as the human eye's sensitivity grows as the illuminance decreases, the illuminance may preferably be in logarithmic relation to the illumi value. FIG. 5 illustrates a logarithmic relation between the illuminance (in lux or lx) and the illumi value. In FIG. 5, the horizontal and vertical axes represent the illuminance and the illumi value, respectively.

If the illuminance detected by the illuminance sensor 19 is low, the control circuit 27 performs a correction process for decreasing the chroma. Thus, visibility in a dark environment may be prevented from being degraded as a characteristic is used such that human eyesight is more likely to be dominated by sensitivity on a lightness axis in the dark environment. That is, dependency on the illuminance may be reduced.

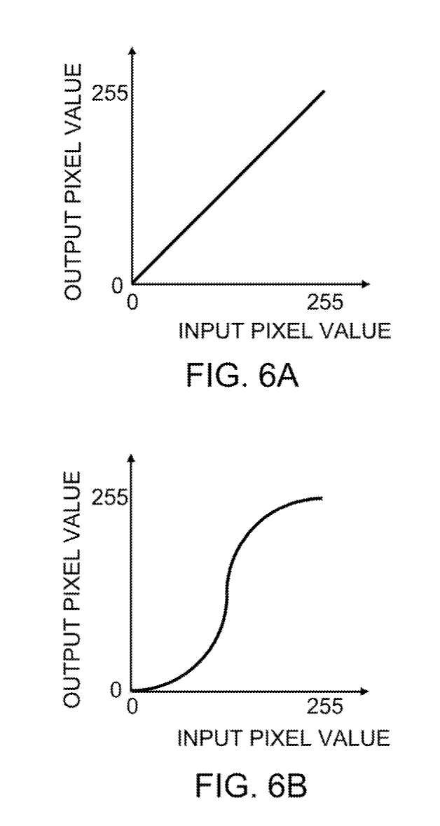

Further, if the illuminance detected by the illuminance sensor 19 is low, the control circuit 27 may perform a correction process for stressing the contrast. In that case, the visibility may be prevented more from being degraded in the dark environment. FIGS. 6A and 6B illustrate an exemplary process for stressing the contrast. FIG. 6A illustrates the contrast in ordinary condition (in a light environment). In FIG. 6A, input and output pixel values agree with each other. Meanwhile, in a dark environment, the control circuit 27 may perform a correction process for making dark and light portions darker and lighter, respectively, e.g., by making a tone curve S-shaped, histogram conversion, etc.

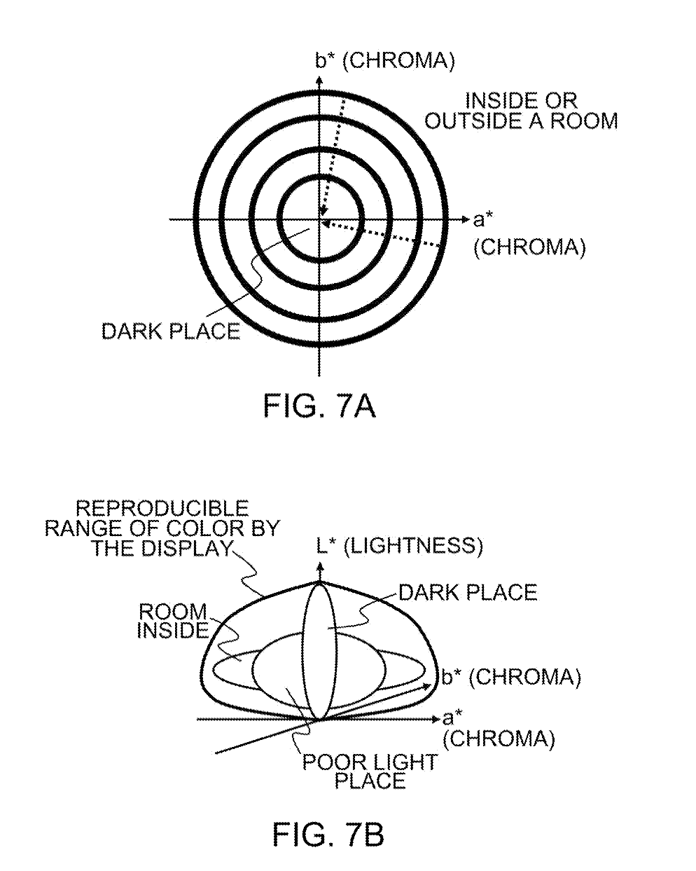

FIGS. 7A and 7B are image diagrams for illustrating a relationship between the decrease of the chroma and the contrast. FIG. 7A illustrates the a*b* color plane in the L*a*b* color space. In FIG. 7A, the chroma at a point being closer to the center is smaller (the hue becomes weaker), and the chroma at a point being farther from the center is greater (the hue becomes stronger). The control circuit 27 sets the chroma to a value positioned far from the center in the a*b* color plane in an environment of high illuminance such as outdoors, and sets the chroma to a value positioned close to the center in the a*b* color plane in an environment of low illuminance such as in a darkroom.

FIG. 7B illustrates the L*a*b* color space. As illustrated in FIG. 7B, as the chroma decreases as controlled by the control circuit 27, the control circuit 27 converts a distribution of image data on the display device 100 into a shape longer in a direction of the lightness axis. The control circuit 27 may thereby stress the contrast as the chroma decreases. Since the chroma is corrected as described above and so is the contrast, the visibility may be prevented from being degraded in the dark environment.

An example of code to be used for chroma correction and contrast correction processes in accordance with the illumi value detected by the illuminance sensor 19 will be explained below. Incidentally, “illumi” in the following code is an illumi value which corresponds to the illuminance detected by the illuminance sensor 19. In an operation process described below, variables OrgPix.R[ ], OrgPix.G[ ], and OrgPixB[ ] represent R-, G-, and B-components of input image (original image) data. Further, variables xsize and ysize represent the number of horizontal pixels and the number of vertical pixels of the original image data, respectively. Further, variables OutPix.R[ ], OutPix.G[ ] and OutPix.B[ ] represent R-, G- and B-components of final output image data, respectively. A variable monochroPix represents a monochrome pixel value into which the input image (original image) is converted, and is used for the chrome correction process performed later. Variables TmpPix.R[ ], TmpPix.G[ ], and TrinpPix.B[ ] represent image data at a phase of an end of the chroma correction process, and are used for the contrast correction process after that phase. A variable gannma_{—}01˜10[ ] represents a matrix to be used for the chroma correction process and for the contrast correction process in series, and stores at this example a conversion value for an S-curve correction.

//▪Step 1: Reduce Hue Information (Bring Close to Monochrome)

```
for(j=0;j<ysize;j++){
for(i=0;i<xsize;i++){
Byte monochroPix
= OrgPix.R[i+j*xsize]*⅓ + OrgPix.G[i+j*xsize]*⅓ +
OrgPix.B[i+j*xsize]*⅓;
//apply an ordinary equation for conversion into a monochrome display
//the RGB ratio is, although not limited to the above, fixed at this point to
⅓ conveniently
//calculate an output pixel value ... sum up weighted monochrome
pixel values
TmpPix.R[i+j*xsize]
= OrgPix.R[i+j*xsize] * illumi + monochroPix * (1−illumi);
TmpPix.G[i+j*xsize]
= OrgPix.G[i+j*xsize]* illumi + monochroPix * (1−illumi);
TmpPix.B[i+j*xsize]
= OrgPix.B[i+j*xsize]* illumi + monochroPix * (1−illumi);
  }
  }
```

//▪Step 2: Stress Lightness and Contrast (FIG. 5)

```
Byte ganma_01[256] = {...};//matrix 01 for S-curve correction (not
displayed because of too many elements)
Byte ganma_02[256] = {...};//matrix 02 for S-curve correction (not
displayed because of too many elements)
Byte ganma_03[256] = {...};//matrix 03 for S-curve correction (not
displayed because of too many elements)
...
Byte ganma_10[256] = {...};//matrix 10 for S-curve correction (not
displayed because of too many elements)
    //use different matrices for S-curve correction in accordance with the
detected illuminance
    //make the S-curve correction stronger as the illuminance is lower
    if(illumi<0.1){//in case of “illumi” value being smaller than 0.1
for(j=0;j<ysize;j++){
for(i=0;i<xsize;i++){
OutPix.R[i+j*xsize] = ganma_01[TmpPix.R[i+j*xsize]];
OutPix.G[i+j*xsize] = ganma_01[TmpPix.G[i+j*xsize]];
OutPix.B[i+j*xsize] = ganma_01[TmpPix.B[i+j*xsize]];
            }
        }
    }
    else if(illumi>=0.1 && illumi<0.2){//in case of “illumi” value being
greater than or equal to 0.1 and smaller than 0.2
for(j=0;j<ysize;j++){
for(i=0;i<xsize;i++){
OutPix.R[i+j*xsize] = ganma_02[TmpPix.R[i+j*xsize]];
OutPix.G[i+j*xsize] = ganma_02[TmpPix.G[i+j*xsize]];
OutPix.B[i+j*xsize] = ganma_02[TmpPix.B[i+j*xsize]];
            }
        }
    }
...
    else{//else=in case of “ilium” value being greater than or equal to 0.9
for(j=0;j<ysize;j++){
for(i=0;i<xsize;i++){
OutPix.R[i+j*xsize] = ganma_10[TmpPix.R[i+j*xsize]];
OutPix.G[i+j*xsize] = ganma_10[TmpPix.G[i+j*xsize]];
OutPix.B[i+j*xsize] = ganma_10[TmpPix.B[i+j*xsize]];
            }
        }
    }
```

According to the above code, the chroma may be made lower as the illuminance detected by the illuminance sensor 19 is lower. A chroma correction value may thereby be made proper in accordance with the value detected by the illuminance sensor 19. Further, the contrast may be more stressed as the illuminance detected by the illuminance sensor 19 is lower. A contrast correction value may thereby be made proper in accordance with the value detected by the illuminance sensor 19.

If the display is updated every time the illuminance frequently changes, the display device 100 may conceivably be not so convenient to use. Thus, it is acceptable, if the illuminance changes and the change continues for a certain period of time, to perform the above process for correcting the chroma and the contrast and to update the display. As described in Table 2, e.g., a whole range of the illuminance is divided into a plurality of ranges. It is acceptable, if the environmental illuminance changes from one range to another range and remains in the range after the change for a certain period of time, to update the display. Incidentally, the range is preferably divided more finely as the illuminance is lower. That is because as the illuminance is lower, the visibility changes more depending upon the change of the chroma.

TABLE 2

| Ranges | Illuminance (lx) |
|---|---|
| Range 1 | 0-0.1 |
| Range 2 | 0.1-10 |
| Range 3 | 10-100 |
| Range 4 | 100-1000 |
| Range 5 | 1000-10000 |
| Range 6 | 10000-100000 |
| Range 7 | 100000- |

Further, if the illumnance is lower than a particular value, the display does not need to be updated as the image may be seen in some cases in spite of the correction. Further, if the display device 100 is contained in a bag, etc., the display does not need to be updated as the image does not need to be corrected. In case of “Range 1” in Table 2, e.g., the display does not need to be updated.

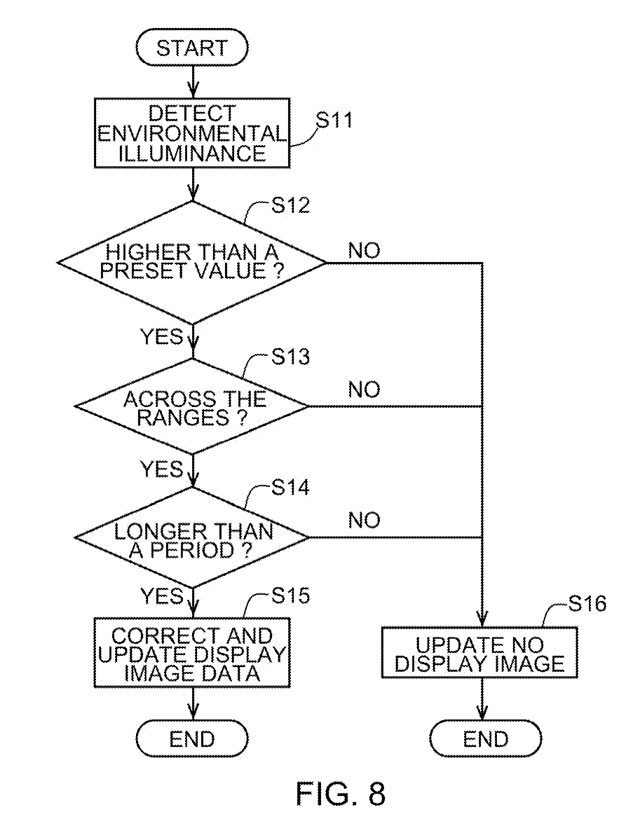

FIG. 8 illustrates an exemplary flowchart for identifying whether the display is updated or not. As illustrated in FIG. 8, the illuminance sensor 19 detects the environmental illuminance of the display device 100 (step S11). Then, the control circuit 27 identifies whether the illuminance detected at the step S11 is higher than a preset value (step S12). If the identification is “No” at the step S12, the control circuit 27 does not update the display (step S16).

If the identification is “Yes” at the step S12, the control circuit 27 identifies whether the environmental illuminance has changed across the ranges in Table 2 (step S13). If the identification is “No” at the step S13, the control circuit 27 does not update the display (step S16). If the identification is “Yes” at the step S13, the control circuit 27 identifies whether the environmental illuminance remains in the same illuminance range for a certain period of time (e.g., 30 seconds) (step S14). If the identification is “No” at the step S14, the control circuit 27 does not update the display (step S16). If the identification is “Yes” at the step S14, the control circuit 27 performs the chroma and contrast correction processes, and controls the common driver 28 and the segment driver 29 so as to update the display (step S15).

According to the flowchart illustrated in FIG. 8, the display is prevented from being unnecessarily updated. Incidentally, as a display device for static image use such as electronic paper does not need to frequently update the display, it is acceptable to carry out the flowchart illustrated in FIG. 8 at regular intervals (e.g., every couple of seconds).

The display device of three colors (red, green, and blue) was described as to the embodiment, and the display device is not limited to that type. The embodiment may be applied, e.g., to a two-color display device including yellow and blue color components.

### Second Embodiment

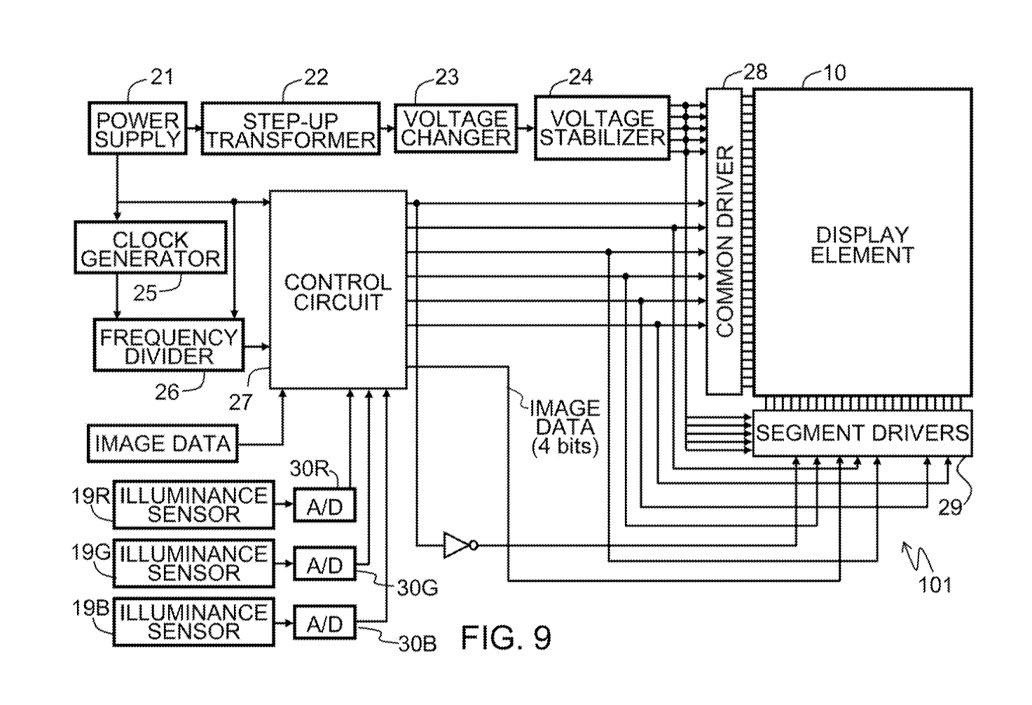

The illuminance sensor may individually detect the illuminance of each of the color components. FIG. 9 is a functional block diagram of a display device 101 of a second embodiment. The display device 101 differs from the display device 100 in that the display device 101 has an illuminance sensor for each of the color components. The display device 101 has an illuminance sensor 19R which detects illuminance of red color, an illuminance sensor 19G which detects illuminance of green color and an illuminance sensor 19B which detects illuminance of blue color.

If, e.g., reddish environment light is intense around a candle, etc., at dusk, it is acceptable to raise ratios of blue and green colors which are complementary to red. Further, as green and blue components of the original image data are invisible in red and dark environment light lacking green and blue components, it is acceptable to selectively raise the ratios of the green and blue components. In case of correction totally dependent on the complementary color component only, however, bright red environmental light, e.g., makes a red letter hard to read. It is thereby preferable to set a bias level common to the R, G, and B, that is RGB, components.

An example of code to be used for chroma correction and contrast correction processes in a case where illuminance is detected for each of the color components will be explained below. Incidentally, the bias level common to the RGB components described above is set to 1/9 as an example in the following code. Incidentally, the contrast correction code may be a same as that of the first embodiment.

//▪Step 1: Reduce Hue Information (Bring Close to Monochrome)

```
for(j=0;j<ysize;j++){
for(i=0;i<xsize;i++){
Byte monochroPix
= OrgPix.R[i+j*xsize]* [ 1/9+(illumi_G + illumi_B)/3] +
OrgPix.G[i+j*xsize]* [ 1/9+(illumi_R + illumi_B)/3] +
OrgPix.B[i+j*xsize]* [ 1/9+(illumi_R + illumi_G)/3];
//convert to monochrome by taking color ratios of environmental light into
account
//the RGB ratio is, although not limited to the above, fixed conveniently
//calculate an output pixel value ... sum up weighted monochrome pixel
values
TmpPix.R[i+j*xsize]
= OrgPix.R[i+j*xsize] * illumi_All + monochroPix * (1−illumi_All);
TmpPix.G[i+j*xsize]
= OrgPix.G[i+j*xsize] * illumi_All + monochroPix * (1−illumi_All);
TmpPix.B[i+j*xsize]
= OrgPix.B[i+j*xsize] * illumi_All + monochroPix * (1−illumi_All);
  }
  }
```

According to the above code, if illuminance of a particular color component is high, the ratio of its complementary color component can be made high. If, e.g., illuminance of the red component is highest, the ratios of the blue and green components can be made high. Further, as the bias level common to the RGB components is set, any particular color component is prevented from being hard to see.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A reflective display device comprising:
an illuminance detector configured to detect illuminance;
a chroma corrector configured to correct chroma of image data in accordance with the illuminance detected by the illuminance detector; and
a display element configured to display the image data corrected by the chroma corrector.

2. The reflective display device according to claim 1, wherein the chroma corrector makes the chroma of the image data lower when the illuminance detected by the illuminance detector is lower than a specified value.

3. The reflective display device according to claim 1, wherein the chroma corrector makes the chroma of the image data lower as the illuminance detected by the illuminance detector is lower.

4. The reflective display device according to claim 1, wherein the chroma corrector corrects the chroma of the image data when the illuminance detected by the illuminance detector remains in a same illuminance range for a specific period of time.

5. The reflective display device according to claim 1, wherein the chroma corrector remains a present chroma of the image data when the illuminance detected is lower than a specified value.

6. The reflective display device according to claim 1, further comprising:
a contrast corrector configured to correct contrast of the image data in accordance with the illuminance detected by the illuminance detector.

7. The reflective display device according to claim 6, wherein the contrast corrector enhances the contrast of the image data when the illuminance detected by the illuminance detector is lower than a specified value.

8. The reflective display device according to claim 7, wherein the contrast corrector makes the contrast of the image data stronger as the illuminance detected by the illuminance detector is lower.

9. The reflective display device according to claim 1, wherein
the illuminance detector detects each of the luminances of corresponding color components, and
the chroma corrector corrects a first color component with higher ratio than those of other color components when the illuminance of a second color component is largest in color components, the first color component being complementary to the second color component.

10. The reflective display device according to claim 1, wherein
the chroma corrector performs a correction of the chroma of the image data in accordance with the illuminance detected by the illuminance detector when the detected illuminance remains in a range for a certain period of time, the range is one of a plurality of ranges each of which is associated with the detected illuminance, and
the ranges associated with low illuminance in the plurality of ranges are divided more finely than those associated with high illuminance.

11. The reflective display device according to claim 6, wherein
the contrast corrector performs a correction of the contrast of the image data in accordance with the illuminance detected by the illuminance detector when the detected illuminance remains in a range for a certain period of time, the range is one of a plurality of ranges each of which is associated with the detected illuminance, and
the ranges associated with low illuminance in the plurality of ranges are divided more finely than those associated with high illuminance.

12. The reflective display device according to claim 1, wherein the display element is capable of storing the display image data.

13. The reflective display device according to claim 1, wherein the display element includes a cholesteric liquid crystal.

14. The reflective display device according to claim 13, the display element is configured to form a layered structure made of a plurality of display elements each of which reflects light of color different from those from other in the plurality of display elements.

15. A controller used for a reflective display device comprising:
a chroma corrector configured to correct chroma of image data in accordance with illuminance detected by an illuminance detector configured to detect the illuminance; and
a contrast corrector configured to correct contrast of the image data in accordance with the illuminance detected by the illuminance detector.
